(19) United States
(12) Patent Application Publication
(10) Pub. No.: US 2024/0067509 A1
(43) Pub. Date: Feb. 29, 2024

(54) Manual Displacement Mechanism, and Method for Displacing a Device

(71) Applicant: Stertil B.V., Kootstertille (NL)

(72) Inventor: Jurjen de Jong, Kootstertille (NL)

(21) Appl. No.: 18/272,215

(22) PCT Filed: Jan. 13, 2022
(86) PCT No.: PCT/NL2022/050008

§ 371 Date: Jul. 13, 2023

(30) Foreign Application Priority Data
Jan. 14, 2021 (NL) 2027317

(51) Int. Cl. B66F 7/20

(52) U.S. Cl. CPC B66F 7/20; B66F 2700/05

(57) ABSTRACT

The invention relates to a manual displacement mechanism and a device provided therewith. The displacement mechanism includes a displacement frame including a housing, and a wheel that is provided at a first end of the housing. The wheel is moveable relative to the frame between a displacement position where the device can be displaced and a stationary position where the device is in a stationary position. The mechanism also includes a steering handle that is operatively coupled to the wheel with a linkage mechanism that is configured for moving the wheel relative to the frame. The steering handle is connected to the displacement frame at a second end of the housing. The mechanism also includes a connector configured for connecting the manual displacement mechanism with the pallet truck or lifting device. The connector includes a hinge for hingedly connecting to the device and a connector spring element configured for providing a pre-tension on the wheel.

### CROSS REFERENCE TO RELATED APPLICATIONS

This application is the United States national phase of International Patent Application No. PCT/NL2022/050008 filed Jan. 13, 2022, and claims priority to The Netherlands Patent Application No. 2027317 filed Jan. 14, 2021, the disclosures of which are hereby incorporated by reference in their entireties.

### BACKGROUND OF THE INVENTION

### Field of the Invention

The invention relates to a manual displacement mechanism, more specifically a displacement mechanism configured for displacement and positioning of a device, such as a pallet truck or lifting device.

### Description of Related Art

Conventional displacement mechanisms comprise a housing, and a wheel that is provided at a first end of the housing, wherein the wheel is moveable relative to the frame between a displacement position wherein the pallet truck or lifting device can be displaced and a stationary position wherein the pallet truck or lifting device is in a stationary position. These conventional displacement mechanisms further comprise a steering handle that is operatively coupled to the wheel with a linkage mechanism that is configured for moving the wheel relative to the frame between the displacement position and the stationary position, and wherein the steering handle is connected to the displacement frame at a second end of the housing.

### SUMMARY OF THE INVENTION

A problem with conventional displacement mechanisms is that these mechanisms are not always effective to provide a stable position in the stationary position in a broad range of circumstances.

An object of the invention is to provide a displacement mechanism that is easy to use and obviates or at least reduces the problems associated with conventional displacement mechanisms.

This object is achieved with a displacement mechanism according to the invention, wherein the displacement mechanism comprising:
a displacement frame comprising a housing, and a wheel that is provided at a first end of the housing, wherein the wheel is moveable relative to the frame between a displacement position wherein the pallet truck or lifting device can be displaced and a stationary position wherein the pallet truck or lifting device is in a stationary position;
a steering handle that is operatively coupled to the wheel with a linkage mechanism that is configured for moving the wheel relative to the frame, and wherein the steering handle is connected to the displacement frame at a second end of the housing; and
a connector configured for connecting the manual displacement mechanism with the pallet truck or lifting device, wherein the connector comprises a hinge for hingedly connecting to the pallet truck or lifting device and a connector spring element configured for providing a pre-tension on the wheel.

According to the invention the displacement mechanism is configured for positioning/displacing a device, such as a pallet truck or a lifting device such as a (mobile) lifting column. An example of such lifting device is a mobile lifting column for lifting vehicles. The displacement mechanism comprises a frame and a moveable wheel. More specifically, the wheel can be moved relative to the frame in a substantial vertical direction between a displacement position and a stationary position. In the stationary position the device, such as a pallet truck or lifting device, rests directly with its foot and/or other frame part on the ground surface thereby providing a stable configuration. This stability is even improved further by the wheel that rests on the floor preferably with some force from the connector spring element. The improved stability better guarantees the safety when working with the manual displacement system of the present invention. It will be understood that wheel may actually also relate to a number of wheels including a wheel assembly of two (or more) wheels. Therefore, a reference to wheel in this description may be interpreted to also include two or more wheels, optionally in a wheel assembly.

Furthermore, the displacement mechanism comprises a steering handle that is operatively coupled to the wheel with a linkage mechanism. The linking mechanism is configured for moving the wheel relative to the frame. This improves ease of positioning or displacing the device, especially including a mobile lifting column. According to the invention the steering handle is connected to the displacement frame at a second end of the housing, while the wheel is provided at the first end of the housing. More specifically, with the displacement frame having a part extending in a substantially vertical direction, the first end of the housing is at or near the bottom side of the displacement frame and the second end of the housing is at or near the upper side of the displacement frame. This specific position for the steering handle improves positioning or displacing the column. More specifically, this position reduces the amount of space that is required when positioning/displacing the device that is provided with such displacement mechanism. Furthermore, this reduces the risk of causing damage to the device or its direct surroundings.

As a further effect, the preferred steering handle according to the invention also reduces the risk of an operator's hand getting jammed or wedged between the displacement frame and the other parts of the frame of the device. This further improves working with such device.

The connector in the displacement mechanism of the invention connects the mechanism with the device. The connector is hingedly connected to the frame or other part of the device. This enables a (preferably small) rotational movement between the displacement mechanism and the device. The connector spring element provides a pre-tension to the wheel such that the wheel improves its contact with the ground, such as a workshop floor, under a wide range of conditions. This increases the stability of the mechanism and the device provided therewith in a wider range of conditions such as larger loads and uneven floors.

By hingedly connecting the connector to the frame of the device the pre-tension can be adjusted effectively. Furthermore, the required manual force is reduced. Especially beneficial is that the connector assists in the lower part of the retraction of the wheel, thereby providing a more ergonomic displacement mechanism.

When retracting the wheel the weight of the device acts in the same or nearly the same direction and, therefore, cooperates. As soon as the wheel loses contact with the floor any further retraction requires full manual power.

For example, in case of a load acting on the wheel of 300 kgf, a spring force of an optional counter spring of 400 kgf, and a connector spring force of 200 kgf, a significant reduction in manual power required for retracting the wheel is achieved. In a presently preferred embodiment, when retracting the wheel the connector spring provides the 200 kgf on the wheel when the wheel loses contact with the ground. Actual lifting of the pallet truck of lifting device only occurs at 300 kgf. This has as an advantage that the manual force that needs to be supplied by the operator/user is reduced from 400 kgf to 200 kgf.

Alternatively, the connector spring element is provided in or at the displacement frame, preferably together with the counter force element. In such embodiment one element may provide the pre-tension of 200 kgf. And the other element may be retracted.

In addition, the connector enables a steering handle configuration that during displacement is substantially horizontal and thereby assists in a stable and easier displacement.

A further advantage of a presently preferred embodiment of the invention is that the connector can be easily and cost-effectively mounted to the device, specifically to a pallet truck or lifting device.

A further effect of providing the connector spring element is its shock absorbing properties when displacing the device. This renders displacement easier for an operator or user. In addition, this reduces the risk of damaging the displacement mechanism and/or device during displacement.

In a presently preferred embodiment of the invention the connector spring element comprises one or more disc springs.

Using one or more disc springs provides an effective and low cost connector spring. Optionally, a module of spring discs can be provided. Also, the use of spring discs renders adjustment of the spring force easier.

In a presently preferred embodiment of the invention the displacement mechanism further comprises a counter force element that is provided in or on the frame.

The counter force element is preferably provided in or on the displacement frame. In its presently preferred embodiment of the invention the counter force element pushes the wheel downward relative to the displacement frame. Preferably, the counter force is such that, in case the pallet truck or mobile lifting column or other device carries a load, the forces acting on the displacement frame are such that the displacement frame moves relative to the wheel against the action of the counter force and moves the displacement frame to its stationary position. This guarantees a safe working environment preventing injuries and/or damage to the column or its surroundings.

Providing the counter force element achieves an effective counter force acting on the wheel of the displacement mechanism. The element is configured such that, without a load acting on the device, in particular a lifting column, the force is such that the frame of the device can be positioned/displaced. The element is also configured such that, when a load is carried by the device, this load exceeds the counter force such that the frame of the device rests on the ground surface of the workshop, for example. This achieves a safe working environment by preventing that the device may roll away from its position when carrying/lifting a load, for example.

Preferably, the counterforce element is a spring element substantially extending along a displacement frame axis between the wheel and the steering handle.

Providing the counter force element as a spring element achieves an effective embodiment of the invention to provide the save working environment.

Preferably, the counterforce is adjustable. By providing an adjustable counterforce the mobile lifting column is flexible in application with different types of devices. This provides a more generic displacement mechanism that can be applied when carrying/lifting different loads. This improves the operational flexibility.

Preferably, the counter force is adjustable between 1000 and 10000 N, more preferably between 1500 and 7500 N, and most preferably between 2000 and 6000 N. These counterforces appear to be appropriate for providing a device that is easy to handle and displace, and also provides a safe working environment

In a presently preferred embodiment the spring element extends with its axis along the axis of the displacement frame. Preferably, the spring element is provided over a substantial part of this axis that preferably connects the wheel and the steering handle. Therefore, in this embodiment the spring element extends between the opposite ends of the housing of the displacement frame. This provides an effective counter force element involving a limited number of parts and is mounted in a (semi-)closed environment. This prevents fouling and malfunctioning of the counter force element. This provides a robust device.

In a further presently preferred embodiment of the invention the linkage mechanism comprises a rod that extends between the wheel at the first end or side of the housing and the handle at the second end or side of the housing, and is furthermore connected to the handle.

Providing a linkage mechanism achieves an effective displacement mechanism. More specifically, by providing the handle at the opposite end of the housing of the displacement mechanism as the wheel, an effective displacement/positioning of the device is made possible. Preferably, the rod acts as axis or shaft of the housing of the displacement mechanism. This provides a robust and stable displacement mechanism.

Preferably, the handle is pivotally connected to the housing at a hinge. The displacement mechanism further preferably comprises a lever or balance with a linkage mechanism being pivotally connected to the lever or balance. This enables easy handling of the displacement mechanism, more specifically easy moving of the wheel between the displacement position and the stationary position. In a presently preferred embodiment the handle itself acts as lever or balance. This achieves an effective displacement mechanism. In a presently preferred embodiment of the invention, the displacement mechanism further comprises a damping element that is configured for damping the movement of the steering handle when moving the device from a stationary position wherein the device is in a stationary (parking) position to a displacement position wherein the device can be displaced. The damper (shock absorber) preferably comprises an oil damper and/or is preferably provided below the handle. This damping element prevents the handle moving upwards too fast with the risk of injuring a user, for example. Preferably, when moving the handle in the other direction the damping element is not functional such that the transfer into the stationary position is not hindered. Alternatively, or in addition thereto, the displacement mechanism comprises an overcenter linkage. Such overcenter linkage is a mechanical stop in the linkage to prevent any “back driving” of such mechanism. The movement of the handle to position the wheel is held by the overcenter mechanism to provide a stable position and thereby a safe working environment.

In a preferred embodiment of the invention the displacement mechanism further comprises a position sensor that is configured for detecting the position of the displacement system.

By providing a position sensor an additional safety measure is provided that detects the actual position, more specifically the actual status, of the displacement system. More particularly, it detects the position of the wheel relative to the displacement frame. Preferably, the use of this position sensor provides a detection of the actual position in addition to the visual inspection of the position of the handle. This improves the safety when working with the lifting column of the invention.

Preferably, the sensor comprises an induction detector that is provided in or on the housing of the displacement mechanism. Preferably, in such embodiment, the sensor further comprises metal bush or profile that moves with the wheel relative to the housing and the detector when moving the wheel between the displacement and stationary positions. This achieves an effective detection of the actual position of the displacement mechanism. This detection is preferably coupled to the controller of the mobile lifting column such that the actual detection may block and/or authorize further operation with the mobile lifting column. This contributes to providing a safe working environment. Optionally, the connectivity module is used to co-operate with further (external) systems, for example for authorizing a displacement of the device.

The invention further relates to a mobile lifting column for lifting a vehicle, the column comprising:
a frame with a moveable carrier, wherein the carrier comprises a carrier part and a guiding part with the carrier being configured for carrying the vehicle;
a drive system which acts on the carrier and is configured for raising and/or lowering the carrier relative to the frame;
a lifting controller configured for controlling movement of the carrier; and
a displacement mechanism according to the present invention.

The mobile lifting column provides the same or similar effects as described in relation to the manual displacement system.

In the context of the present invention the carrier relates to the moving parts of the lifting column when lifting the vehicle. This carrier is driven by a drive, such as a hydraulic drive, pneumatic drive and/or electric drive. The present invention relates to mobile lifting columns, preferably wireless mobile lifting columns.

The carrier of the lifting column is capable of carrying the vehicle that needs to be lifted. The carrier moves upward and/or downward relative to the frame of the lifting column with a drive system. The carrier comprises a carrying part that is configured for carrying a vehicle, or at least a part thereof. The carrier further comprises a guiding part that enables a guiding movement relative to the frame of the lifting column. In one of the presently preferred embodiments of the invention, the drive system comprises a hydraulic cylinder drive unit that is configured for raising the carrier. This unit comprises a housing, a piston rod that is movable in the housing of the cylinder, and a hydraulic system. Alternatively, another drive system can be used, for example a pneumatic and/or electrical drive system. In one of the presently preferred embodiments of the invention the unit is embodied as an integrated hydraulic cylinder drive unit as disclosed in U.S. Patent Application Publication No. 2016/0052757.

In a presently preferred embodiment of the invention the mobile lifting column comprises a movement sensor system configured for detecting a movement of the carrier, wherein the movement sensor system comprises a detector, a pulley that is rotatable around a shaft for enabling movement of a cord or belt, and a movement indication that is provided on or to the pulley and/or cord or belt.

The movement sensor system, also referred to as the movement sensor, detects the movement of the carrier. In a presently preferred embodiment this provides an additional height indication of the carrier. This increases the overall safety when working with the lifting column. For example, such movement sensor may detect a movement of the carrier, while the controller of the lifting column or system expects a stationary position of the carrier. Such detection is optionally fed back to the controller such that appropriate action can be taken and dangerous situations can be prevented. Such unexpected movement of a carrier could occur when a drive cylinder would be leaking, for example. As a further advantage the movement sensor provides a redundancy to the height measurement of the carrier.

Preferably, the detector is configured for detecting the direction of movement. In a presently preferred embodiment the detector is provided with two measurement channels that operate with a phase shift such that the direction of movement of the movement indication can be detected. This enables detection of the lifting or descending movement of the carrier.

In a presently preferred embodiment the movement indication comprises a toothing. Such toothing provides an effective measure to enable a detection of movement of the carrier. For example, the tooting may comprise 30, preferably 40, and more preferably more than 45 teeth such that an accurate movement indication can be detected. Preferably, the direction of movement is also detected.

In a presently preferred embodiment the movement sensor further comprises a reference indication configured for providing a height reference to the movement sensor.

The reference indication enables correction of any height difference that may occur in time, for example caused by switching on and off the mobile lifting column. Accumulated (small) errors may over time lead to significant measurement errors. Providing the reference indication prevents such errors and provides a reliable height measurement.

The reference indication can be provided in different ways. For example, the reference indication or reference sensor can be provided by a foot protection system that is often provided at a height of about 120 mm above the workshop floor. At this height the carrier stops with the descending movement and only continues after the operator confirms the desired descending movement. This safety measure can also be used a reference indication for the movement sensor, for example as a default height reference. It will be understood that other reference indications can also be provided, including dedicated height references.

In a presently preferred embodiment the mobile lifting column further comprises an indirect height measurement system.

The indirect height measurement system measures the height of the carrier indirectly. For example, the indirect height measurement system may measure changes in the hydraulic system such that any measurement of a displacement of the carrier is directly available, thereby preventing time delays and, if necessary, enabling appropriate control actions to be taken directly. This may improve the safety of the lifting column according to the present invention.

The lifting column according to the invention preferably comprises a controller that is configured for controlling the movement, preferably including the height, of the carrier. The controller can be provided at or in the frame of the lifting column, or may in addition, or as an alternative, relate to a central controller capable of controlling a number of lifting columns/devices and/or several groups of lifting columns/devices, or any mixture thereof. By monitoring and controlling movements of all carriers the controller is capable of controlling the position of a vehicle that is being lift with the columns. Preferably, the controller also comprises a display and optionally other user interfaces to enable communication with the user. Also, the controller may comprise a display to improve this communication.

The controller is preferably configured for controlling movement of the carrier in response to a measurement signal from the movement sensor and/or indirect height measurement system and/or any other suitable sensor, for example a sensor or sensor system on the carrier or frame such as a potentiometer. This provides direct and/or indirect measurement information enabling feedback on the actual position and/or displacement of the carrier, height difference of the carrier(s), moving speed of the carrier, information about the control actions directed towards the drive, such as the amount of hydraulic oil sent to the drive for raising or lowering the carrier relative to the frame, and enables appropriate control action(s).

In one of the preferred embodiments of the invention the controller acts on a direct or indirect height measurement of the carrier and takes appropriate control actions. The movement sensor may act as an additional sensor to provide an additional safety measure. Alternatively, the measurements of the movement sensor are included in the primary control action, for example by taking the average of the available measurements, optionally with an appropriate weighing factor. In addition, or as an alternative, detection of leakage can be provided by comparing the available measurements.

In a further preferred embodiment the lifting column further comprises a locking mechanism for mechanically locking the carrier at a desired height, wherein the locking mechanism comprising a moveable locking element capable of locking and unlocking the carrier, a lock sensor for measuring the position of the locking element, and a locking controller that is configured for detecting locking of the carrier in response to the locking sensor and an operator input for lowering the carrier.

The mechanical locking mechanism locks the carrier at a desired height to provide a safe working environment. In a presently preferred embodiment such mechanism involves a safety ratchet device having a series of successive stop elements in the longitudinal direction of the frame that define a lock or stop surface, and a locking element to which is also referred to as a ratchet element, that may come into contact with a stop element in a locking position. In an unlocking or retracted position the stop elements can pass freely relative to the locking element. The locking element can be activated after the carrier or carriers of the lifting device or devices have reached the desired height. In a presently preferred embodiment the moveable locking element comprises a locking pawl. Such pawl provides a stable and robust locking element.

A lock sensor is provided for measuring the position of the locking element. By directly measuring the actual position of the locking element the locking or unlocking state of the mechanism is determined directly. This provides a safe locking mechanism that provides safety indications correctly under a much broader range of operating conditions as compared to conventional mechanisms. For example, when using axle stands the load is actually removed or at least its weight is largely reduced from the carrier or carriers and the load is moved to the stands. This may give a lifting controller the impression that the load is safely supported by the locking mechanism, such that a safe working environment is achieved. This is not necessarily true and depends on the axle stands, for example. In a worse case scenario, this may even result in accidents due to the false detection of a safe working environment. Providing a direct lock sensor that directly measures the actual position of the locking element enables a direct detection of the actual status of the locking mechanism. This obviates any false-detections such that a safe working environment can be achieved. This improves the overall safety of working with a lifting device for lifting a vehicle.

The lock sensor preferably comprises a position indicator that may operate (electro)mechanically, inductively or optically. It will be understood that different types of lock sensors can be applied for the direct measurement of the actual position of the locking element. The lock sensor is operatively connected to the locking controller. Preferably, the locking controller is integrated in the control system of the lifting column(s). The locking controller receives the lock sensor signal. Furthermore, the locking controller directly or indirectly receives the operator input of a lowering instruction for the carrier. The locking controller is informed about an intended lowering of the carrier and detects the arrival in the locking position with the lock sensor in combination with the discontinued lowering movement. This provides an even further increased certainty that the carrier is correctly locked, such that a safe system is provided.

By providing the controller with the measurement signal from the lock sensor and operator input the controller is capable of detecting a safe or unsafe situation. The controller may provide warning signals and may also enable and/or disable operation of the lifting device or lifting system as a whole. This contributes to the safety of the working environment.

Preferably, the lock sensor and/or locking controller are connected with a connector to the control system of the lifting device, so that the actual status of the lock sensor can be indicated on the control panel, preferably on a display thereof. By providing a display, an operator of the lifting device is provided with an overview of the actual status of the lifting device, more specifically in relation to the actual position of the locking element. The display can be one or more of a display of the lifting device such as a touch screen, a display on a remote control, or a central display that is capable of visualising the status of locking elements of different lifting devices.

Visualisation of the actual status of the locking elements or unlocking elements can be done in various ways. For example, a green screen or green element can be displayed when the locking element or locking elements are in the locking position, such that all the carriers are supported by the locking element, such as the locking pawl. In presently preferred embodiments this means that the lifting device or lifting system has reached its desired height and the carriers are brought into a position that a mechanical locking system is activated, for example by a user. In the visualisation a red background colour or element may indicate that the locking element or pawl is inactive and is in a retracted position. In an intermediate situation, the background colour or element colour can be orange indicating that the locking element or pawl is in an active locking state, however, the locking pawl is not yet activated in this state. Optionally, in addition, visualization may also use a light element attached or connected to the lifting device or at another location, for example centrally in the work place. Furthermore, in addition to any visual indication, also a sound signal can be used to improve the message or signal to the operator. Furthermore, in addition or as an alternative to the sound signal, a signal can be provided to a supervisor to enable this supervisor to check that working conditions are safe.

In a further preferred embodiment of the invention the lifting column further comprises a locking system for locking and unlocking the moveable carrier relative to the frame, wherein the locking system comprises an electromagnetic lock actuator and an electromagnetic locking drive configured for moving the lock actuator between a locked state and an unlocked state, wherein the locking drive provides a first moving voltage and a second holding voltage that is lower than the first moving voltage.

Activating the lock with a lock actuator and a locking drive that are configured for moving the lock actuator between a locked state and an unlocked state enables the lock to engage or disengage. This preferably involves an electromagnetic lock actuator and locking drive. For moving the lock actuator a higher moving voltage is applied as compared to the holding voltage in the locked state. This voltage reduction when being in the locked state reduces energy requirements such that the overall energy consumption of working with the lifting column(s) is significantly reduced. In addition, excessive heating of parts is prevented.

Experiments showed that a voltage reduction of 25 to 50% between the moving voltage and the holding voltage is possible. In one of the presently preferred embodiments this is achieved using pulse width modulation (PWM). It will be understood that other options can also be envisaged. This provided a significant contribution to the reduction of the energy consumption when working with the lifting column(s). Preferably, the applied frequency in the PWM is adapted to the natural frequency or eigenfrequency to prevent resonances.

In one of the presently preferred embodiments the locking system of the lifting device of the present invention comprises a lock activator and a locking rail that both extend over at least a part of the height of the frame. A lock is provided at or on the moveable carrier and is configured for engaging and/or disengaging the locking rail in response to the movement of the actuator. Preferably, the lock is provided at the guiding part of the moveable carrier. Providing the lock at the carrier enables a reduction of the height of the guiding part of the carrier. This significantly reduces the amount of material that is required for the carrier. Therefore, the overall weight of the carrier is significantly reduced without influencing the performance of the lifting device. This reduces manufacturing costs, improves operational efficiency when working with the lifting device of the present invention, and may also reduce transportation costs. As a further advantage the carrier can be locked at any desired position along the frame of the lifting device. This significantly reduces the locking pitch that is present in conventional lifting devices. It also contributes to a safe and user friendly operation of the lifting device in one of the embodiments of the present invention.

In a presently preferred embodiment of the invention the lock preferably comprises a pawl, lock, block, pen or rod-like element that moves to and from the locking rail that is attached or provided in the frame when engaging or disengaging the carrier. Preferably, the locking rail comprises a number of teeth shaped like a gear rack that extends over a substantial part of the height of the frame.

In a further presently preferred embodiment of the invention the lifting column comprises a wireless communication controller configured for wireless communication with a controller and/or other lifting columns, and a wired connection to an energy source, in particular an external energy source.

Wireless communication enables easy replacement of a column in a set of columns and/or renders the setting of a set of lifting columns relatively easy. Providing a wired connection to an energy source obviates the need for batteries in the lifting column. It is noted that conventional (mobile) lifting columns are provided with an individual battery acting as an internal energy source. This obviating of batteries reduces weight and costs. Furthermore, the risk of malfunctioning due to battery failure is prevented. Optionally, lifting columns of a set of lifting columns are individually connected to an external energy source. Alternatively, columns are connected to each other and only one or some columns of the set is connected to the external energy source.

The external energy source may comprise the grid. In addition, or as an alternative, the external energy source comprises a vehicle battery, preferably a vehicle battery of the vehicle involved in the present lifting operation. In addition, or as an alternative, a solar panel of strip is provided to generate the energy required for operating the lifting column(s). Preferably, the solar panel or strip is provided on or at the lifting column. In addition, or as an alternative, a fuel cell is provided to generate the energy required for operating the lifting column(s). Optionally, the fuel cell is configured for charging a battery. In addition, or as an alternative, energy is provided to the lifting column using an inductive generator. The energy can be used directly and/or can be stored in a battery. The generator may involve a charging plate, charging strip and/or any other suitable charging element.

In presently preferred embodiments of the invention the external energy source is applied in combination with regeneration of energy by the lifting column. This may involve regenerating the lifting energy when lowering a vehicle. This may provide a stand alone lifting column that is self-sufficient. This renders such column energy efficient, stand-alone, and very flexible.

In presently preferred embodiments of the invention the lifting column further comprises a battery safety circuit configured for preventing overcharging of a battery.

When lowering a vehicle (hydraulic) energy can be regenerated and used for charging a battery. This increases the amount of lifts that can be performed on one battery charge. In case a battery is already charged this may result in overcharging and damaging the battery. Providing a battery safety circuit prevents such overcharging and improves the lifespan of the battery.

In one of the presently preferred embodiment a throttle valve, such as a pulse width modulation (PWM) valve is provided in the battery safety circuit. In case of a battery being (almost) fully charged the valve restricts the flow through the pump and thereby restricts the regeneration. In addition or as an alternative overflow or discharge valve(s) are provided to reduce the amount of (re)generated energy. Furthermore, the motor can be operated in a relatively ineffective point of operation to reduce the amount of energy that is (re)generated. Also, the energy that is being generated can be provided to a resistor and/or capacitor to reduct the energy that is proved to the battery. It will be understood that these measures can be applied separately or in different combinations to prevent overcharging a battery when (re)generating energy.

In a further presently preferred embodiment of the invention the lifting column further comprising a distancing system.

A distancing system provides a safety barrier around the working zone of a set of lifting columns. This improves safety conditions when working with lifting columns. In a presently preferred embodiment the distancing system comprises an extendable arm that is provided with a barrier lint or similar barrier element. Such element can be connected to another column to provide a safety barrier around the set of lifting columns.

The invention further relates to a lifting system comprising a number of mobile lifting columns according to an embodiment of the present invention.

Such lifting system provided the same or similar effects and advantages as described in relation to the lifting column.

The invention further relates to a method for displacing a device, the method comprising the steps of:
providing displacement mechanism according to an embodiment of the present invention;
bringing the displacement mechanism from a stationary position to a displacement position;
moving the device; and
bringing the displacement mechanism from the displacement position to the stationary position.

Such method provides the same or similar effects and advantages as described in relation to the displacement mechanism.

In a presently preferred embodiment of the method the device is a mobile lifting column according to an embodiment of the invention. Such method provides the same or similar effects and advantages as described in relation to the mobile lifting column and/or lifting system. Such device is optionally provided with one or more of the features presented here, such as a battery safety circuit and a distancing system.

The invention further relates to a mobile lifting column for lifting a vehicle, the column comprising:
a frame with a moveable carrier, wherein the carrier comprises a carrier part and a guiding part with the carrier being configured for carrying the vehicle;
a drive system which acts on the carrier and is configured for raising and/or lowering the carrier relative to the frame;
a lifting controller configured for controlling movement of the carrier; and
a movement sensor system configured for detecting a movement of the carrier, wherein the movement sensor system comprises a detector, a pulley that is rotatable around a shaft for enabling movement of a cord or belt, and a movement indication that is provided on or to the pulley and/or cord or belt.

Such lifting column provides the same or similar effects and advantages as described in relation to the displacement mechanism, column provided therewith, and method for lifting a vehicle.

In presently preferred embodiments the detector is configured for detecting the direction of movement and/or wherein the movement indication comprises a toothing. This provides the same or similar effects and advantages as described earlier. Such device is optionally provided with one or more of the features presented here, such as a battery safety circuit and a distancing system.

The invention further relates to a mobile lifting column for lifting a vehicle, the column comprising:
a frame with a moveable carrier, wherein the carrier comprises a carrier part and a guiding part with the carrier being configured for carrying the vehicle;
a drive system which acts on the carrier and is configured for raising and/or lowering the carrier relative to the frame;
a lifting controller configured for controlling movement of the carrier; and
a locking mechanism for mechanically locking the carrier at a desired height, wherein the locking mechanism comprising a moveable locking element capable of locking and unlocking the carrier, a lock sensor for measuring the position of the locking element, and a locking controller that is configured for detecting locking of the carrier in response to the locking sensor and an operator input for lowering the carrier.

Such lifting column provides the same or similar effects and advantages as described in relation to the displacement mechanism, column provided therewith, and method for lifting a vehicle. Such device is optionally provided with one or more of the features presented here, such as a battery safety circuit and a distancing system.

The invention further relates to a mobile lifting column for lifting a vehicle, the column comprising:
a frame with a moveable carrier, wherein the carrier comprises a carrier part and a guiding part with the carrier being configured for carrying the vehicle;
a drive system which acts on the carrier and is configured for raising and/or lowering the carrier relative to the frame;
a lifting controller configured for controlling movement of the carrier; and a locking system for locking and unlocking the moveable carrier relative to the frame, wherein the locking system comprises an electromagnetic lock actuator and an electromagnetic locking drive configured for moving the lock actuator between a locked state and an unlocked state, wherein the locking drive provides a first moving voltage and a second holding voltage that is lower than the first moving voltage.

Such lifting column provides the same or similar effects and advantages as described in relation to the displacement mechanism, column provided therewith, and method for lifting a vehicle. Such device is optionally provided with one or more of the features presented here, such as a battery safety circuit and a distancing system.

The invention further relates to a mobile lifting column for lifting a vehicle, the column comprising:
a frame with a moveable carrier, wherein the carrier comprises a carrier part and a guiding part with the carrier being configured for carrying the vehicle;
a drive system which acts on the carrier and is configured for raising and/or lowering the carrier relative to the frame;
a lifting controller configured for controlling movement of the carrier; and
a wireless communication controller configured for wireless communication with a controller and/or other lifting columns, and a wired connection to an energy source.

Such lifting column provides the same or similar effects and advantages as described in relation to the displacement mechanism, column provided therewith, and method for lifting a vehicle.

Providing a wired connection to an (external) energy source may obviate the need for batteries in the lifting column, as mentioned earlier in this description. This reduces weight and costs. Furthermore, the risk of malfunctioning due to battery failure is prevented or at least reduced. Optionally, lifting columns of a set of lifting columns are individually connected to an external energy source. Alternatively, columns are connected to each other and only one or some columns of the set is connected to the external energy source.

The external energy source may comprise the grid. In addition, or as an alternative, the external energy source comprises a vehicle battery, preferably a vehicle battery of the vehicle involved in the present lifting operation. In addition, or as an alternative, a solar panel of strip is provided to generate the energy required for operating the lifting column(s). Preferably, the solar panel or strip is provided on or at the lifting column. In addition, or as an alternative, a fuel cell is provided to generate the energy required for operating the lifting column(s). Optionally, the fuel cell is configured for charging a battery. In addition, or as an alternative, energy is provided to the lifting column using an inductive generator. The energy can be used directly and/or can be stored in a battery. The generator may involve a charging plate, charging strip and/or any other suitable charging element.

In presently preferred embodiments of the invention the external energy source is applied in combination with regeneration of energy by the lifting column. This may involve regenerating the lifting energy when lowering a vehicle. This may provide a stand alone lifting column that is self-sufficient. This renders such column energy efficient, stand-alone, and very flexible.

Such device is optionally provided with one or more of the features presented here in this description, such as a battery safety circuit and a distancing system.

Optionally, the lifting controller of an individual lifting column controls a set of lifting columns that are selected for a lifting system. Alternatively, a combination of (some of the) lifting controllers of lifting columns in a lifting system jointly control the system. Also alternatively, a separate (central) controller is provided to control all columns in a lifting system. In all these different embodiments the controller(s) that control(s) the lifting columns that are selected for a set of lifting coumns can be referred to as a central controller for the lifting system.

It is noted that features mentioned in relation to the system(s) can be applied to the method according to the invention, and vice versa.

The terms Fig., Figs., Figure, and Figures are used interchangeably in the specification to refer to the corresponding figures in the drawings.

### BRIEF DESCRIPTION OF THE INVENTION

Further advantages, features and details and of the embodiment will be elucidated on the basis of preferred embodiments therefor, wherein reference is made to the accompanying drawings, in which:

FIG. 1 shows a manual displacement system according to the invention;

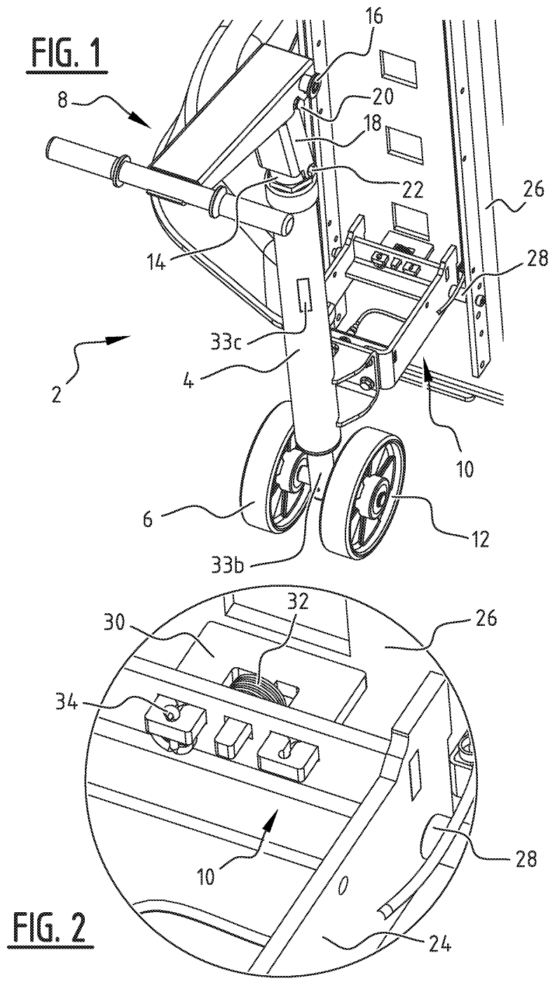

FIG. 2 shows the connector of the system of FIG. 1;

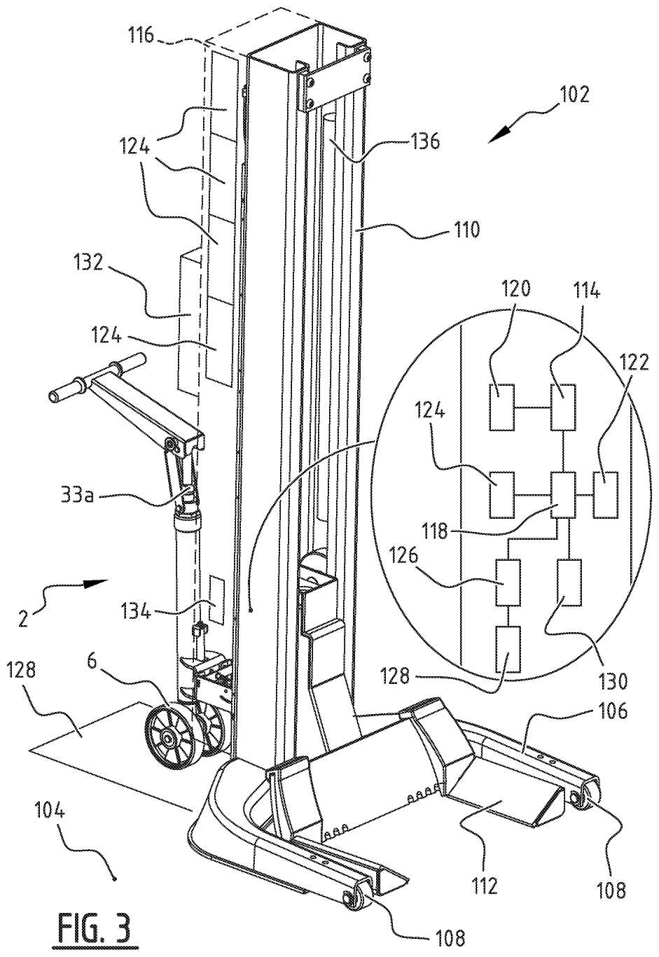

FIG. 3 shows a mobile lifting column comprising the manual displacement system of the invention;

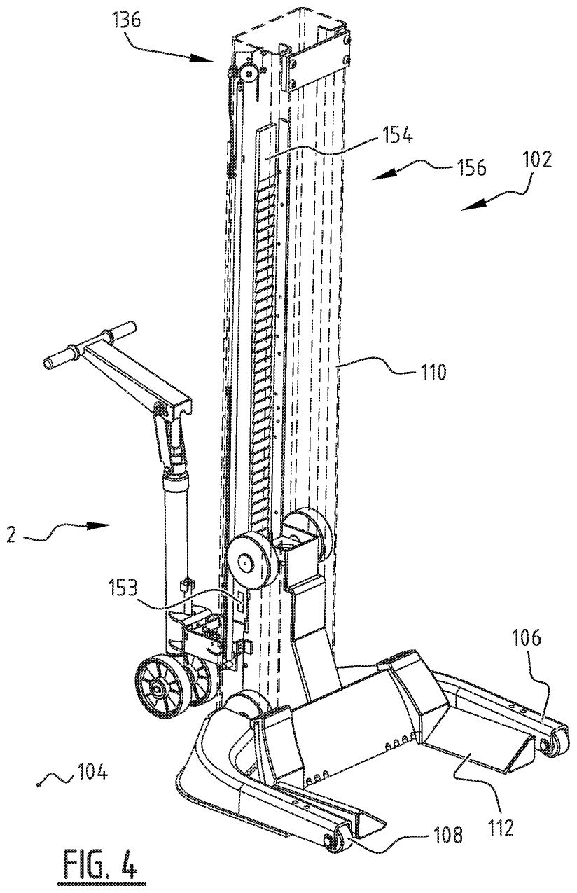

FIG. 4 shows another view of the column of FIG. 3;

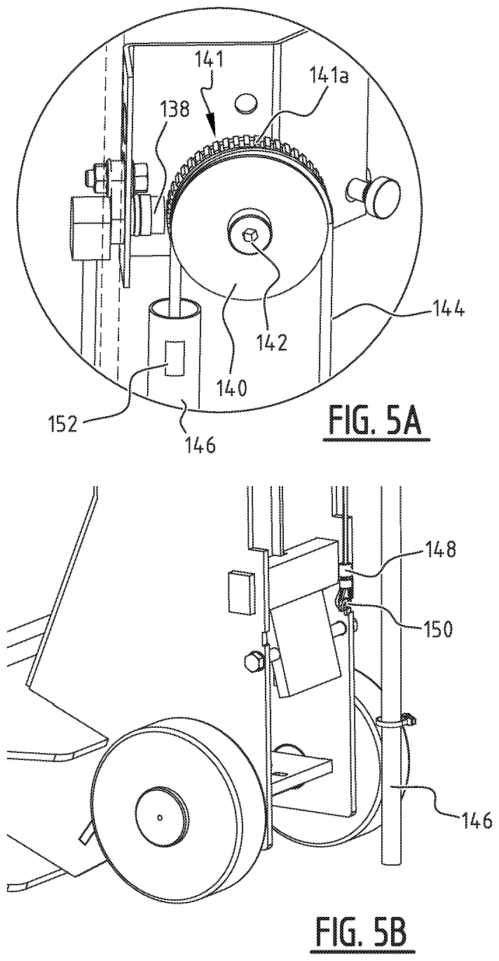

FIGS. 5A-B shows the movement sensor of the columns of FIGS. 3 and 4;

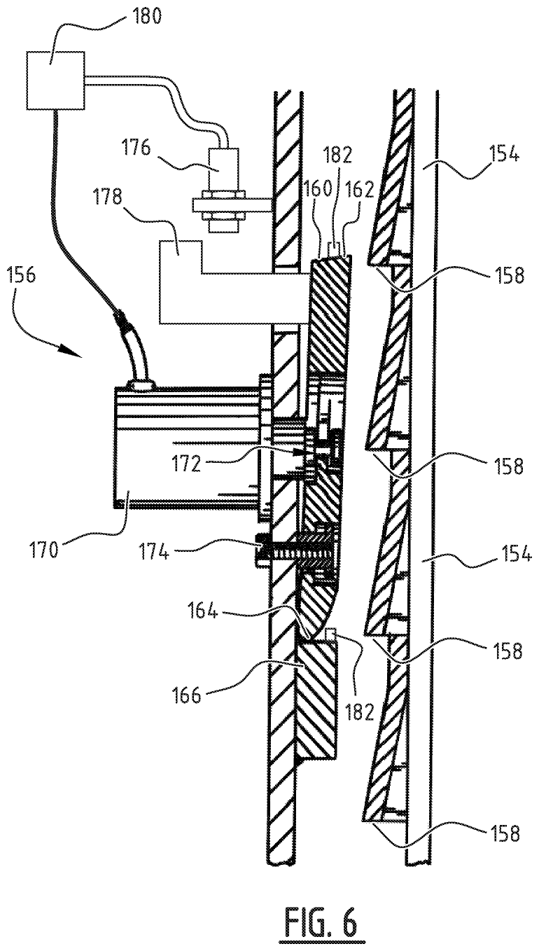

FIG. 6 shows the locking system of the columns of FIGS. 3 and 4;

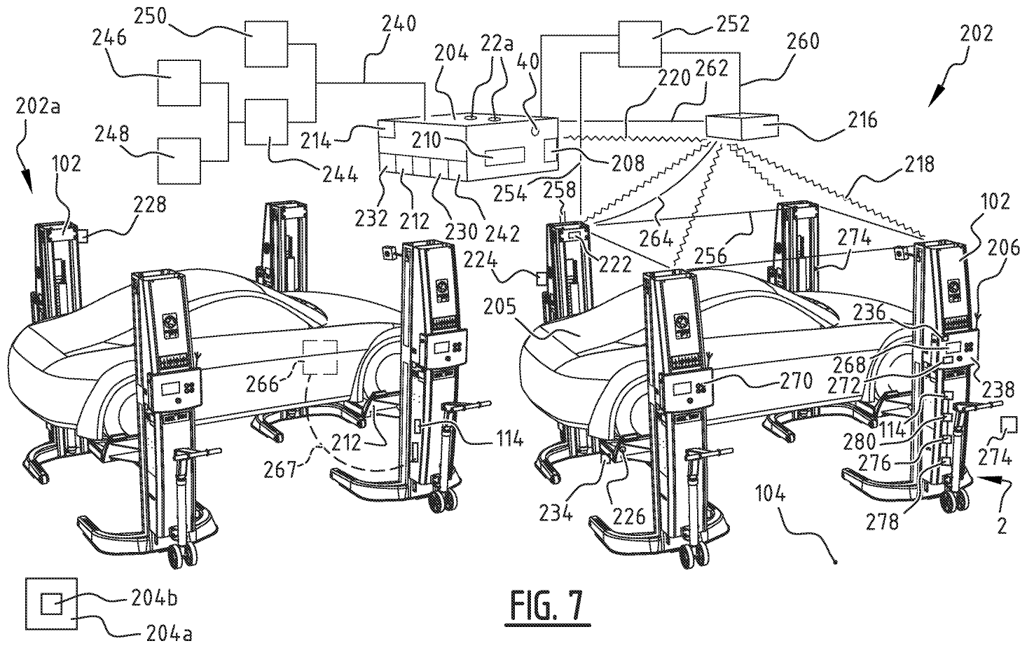

FIG. 7 shows a lifting system according to the invention comprising a number of columns of FIGS. 3 and 4;

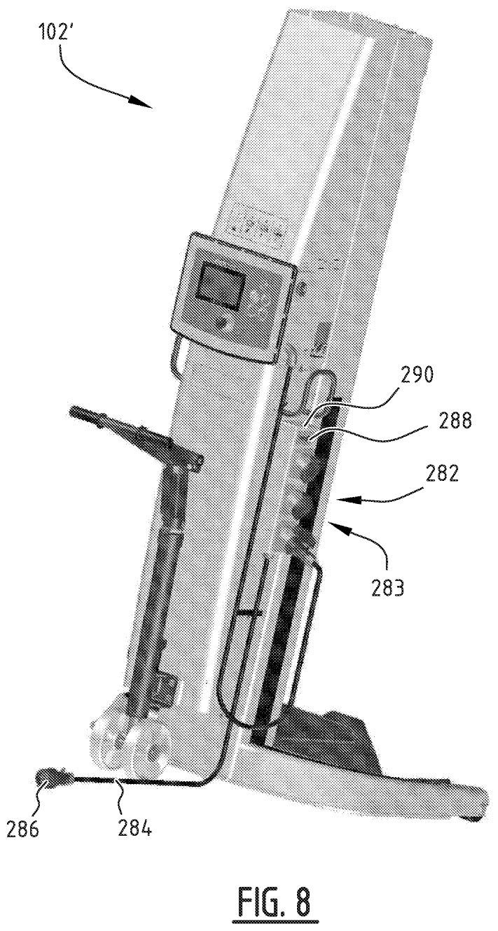

FIG. 8 shows a lifting column with connection to power supply;

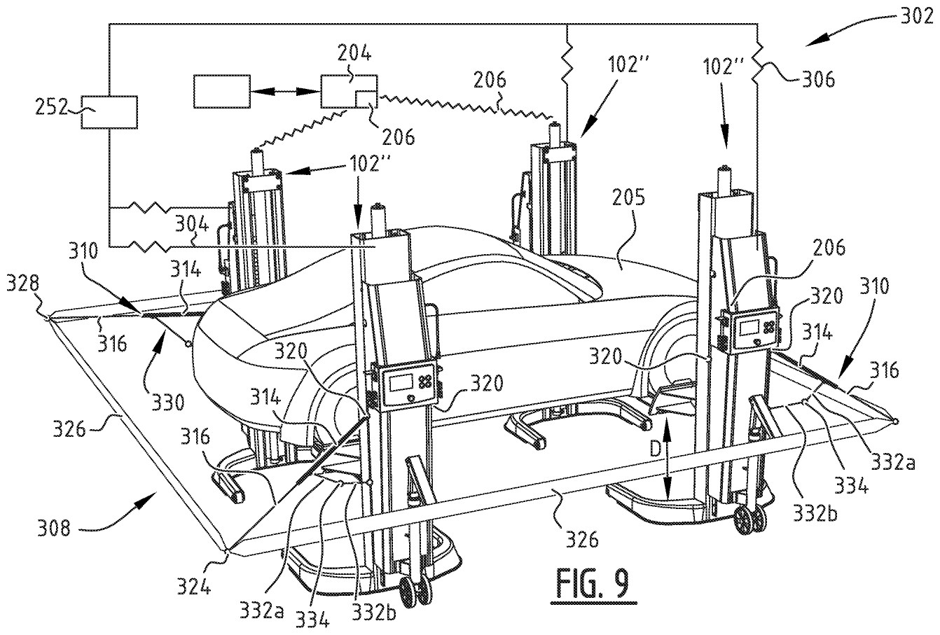

FIG. 9 shows a lifting system in alternative embodiments according to the invention comprising a set of lifting columns; and

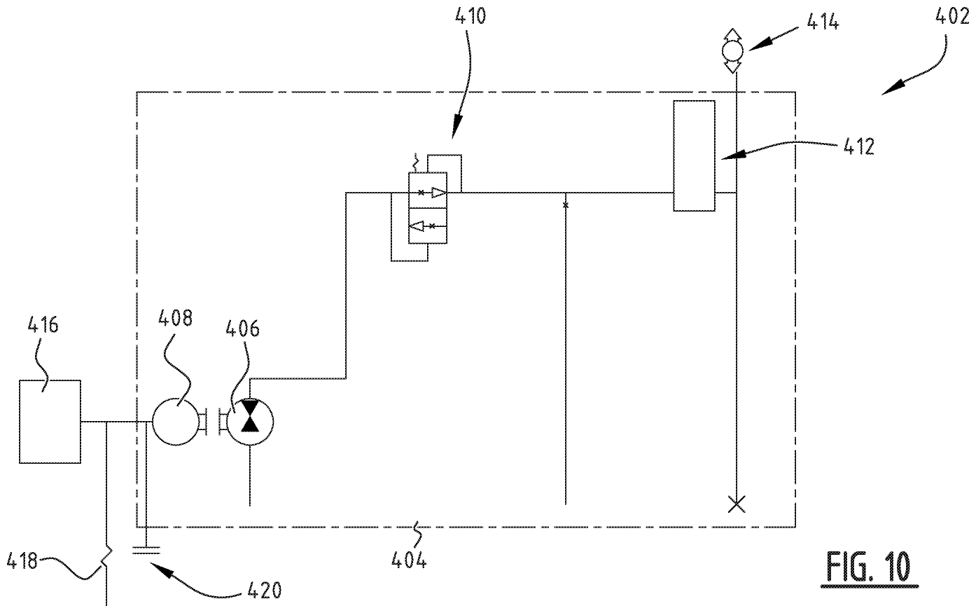

FIG. 10 shows an embodiment of a hydraulic scheme of a lifting column according to the invention.

### DESCRIPTION OF THE INVENTION

The following description is merely exemplary in nature and is in no way intended to limit the invention, its application, or uses. While the disclosure is described as having exemplary attributes and applications, the present disclosure can be further modified. This application is therefore intended to cover any variations, uses, or adaptations of the disclosure using its general principles. Further, this application is intended to cover such departures from the present disclosure as come within known or customary practice of those skilled in the art to which this disclosure pertains and which fall within the limits of the appended claims. Accordingly, the following description of certain embodiments and examples should be considered merely exemplary and not in any way limiting.

Manual displacement system 2 (FIG. 1) comprises frame 4 with wheel(s) 6, and steer handle 8. Connector 10 is provided to connect manual displacement system 2 to another device 26. One or more wheels 6 may rotate around shaft 12. Rod or shaft 14 extends through frame or housing 4 between wheel(s) 6 and steer handle 8. Handle 8 is pivotally connected to rod 14 at hinge 16. Linkage 18 extends between handle 8 at hinge 20 and rod 14 at hinge 22.

Connector 10 (FIG. 2) comprises connecting linkage 24 that extends between manual displacement system 2 and device 26. Rotation axis 28 enables rotation of linkage 24 relative to device 26. It will be understood that other configurations of such rotation axis can also be envisaged in accordance to the present invention. In the illustrated embodiment mechanical stop 30 is attached to the frame of device 26. In addition, one or more spring discs 32 are provided. Locking pin 34 assures the connection between displacement system 2 and device 26.

Optionally, displacement system 2 comprises adjustment screw 33a (FIG. 3) that is attached to rod or shaft 14. Screw 33a enables adjustment of counter force that is preferably applied to displacement system 2. Connecting rod 33b (FIG. 1) is connected to shaft 12 of wheel 6 and to rod 14. In a presently preferred embodiment connecting rod 33b extends along rod 14, optionally moving with a separate metal bush (not shown). Optionally, spring 33c (schematically illustrated) is provided between rod 14 and connecting rod 33b or the bush, to provide the aforementioned counter force. Adjustment screw 33a enables setting the counter force that is achieved by spring 33c. Optionally, a damping element is provided below steering handle 8 to damp the movement of handle 8 from the stationary to the displacement position. When moving handle 8 from the displacement position to the stationary position damping element has preferably no substantial effect.

When positioning device 26, displacement system 2 is in the displacement position wherein device 26 can be moved. When device 26 has reached its desired position, steering handle 8 is moved downwards, involving movement of overcenter linkage 18, to the stationary position. Preferably, in this stationary position, wheel 6 remains on the ground to improve the stability of device 26 when performing operations, such as a lifting operation.

After the operation with device 26 has ended, displacement mechanism 2 can be brought from the stationary position to the displacing position by moving steering handle 8 in upwards direction. Spring element(s) 32 contribute to the effective upwards movement and enable a user friendly movement of handle 8. This upwards movement of handle 8 enables moving lifting column 4 to another position/location.

It will be understood that manual displacement system 2 can be provided in different configurations according to the present invention. Optionally, a separate drive is provided for moving system 2 between locations after, preferably manually, lifting handle 8.

Manual displacement system 2 can be used in combination with different devices 26. In one of the presently preferred embodiments system 2 is used for mobile lifting column 102 (FIG. 3). Mobile lifting column 102 of the present invention is suitable for use with lifting systems comprising any number of lifting columns, including systems having one, two, four or another number of columns. The columns may achieve lifting and lowering capability by any means known to those of skill in the art, including hydraulically, electrically, mechanically, and electromechanically. Lifting systems compatible with the present mobile lifting column may be capable of being transported via wheels or any other suitable means known to those in the art. With reference to the figures, like element numbers refer to the same element between drawings.

Mobile lifting column 102 (FIG. 3) is positioned on ground surface 104 of for instance a floor of a garage or workshop, and comprises foot 106 which can travel on running wheels 6, 108 over ground surface 104. Running wheel(s) 6 is/are part of displacement system 2 enabling easy manoeuvring of lifting column 102. Lifting column 102 furthermore comprises mast 110. Carrier 112 is moveable upward and downward along mast 110. Optionally, adapters can be used to adjust carrier 112 to specific wheel dimensions. Carrier 112 is driven by motor/drive system 114 that is schematically illustrated and is provided in housing 116 of lifting column 102. In one embodiment, the motor of system drive 114 is a 3-phase low voltage motor controlled by a separate controller. In another embodiment, the motor of system 114 is a 3-phase low voltage motor with integrated controller. Such motor with integrated controller can also be used in combination with conventional lifting columns with conventional height measurement systems. Motor 114 is operatively coupled to cylinder 136 (schematically illustrated in FIG. 3) that is capable of moving carrier 112. Motor 114 is supplied with power from the electrical grid 120 or, in addition or alternatively, by one or more batteries 118 that is provided on lifting column 4 in the same housing as motor 114, or alternatively on foot 106 (not shown). Alternatively, or in combination with the other energy sources, fuel cell 122, solar panel or strip 124, inductive charger 126 with optional charger plate 128 and/or regenerative system 130 are provided to provide power to lifting column 102. Solar panel or strip 124 may comprise a panel or strip that is positioned distant from column 102 (not shown) and/or may comprise a panel or strip that is attached to or on lifting column 102. In the illustrated embodiment solar strip or strips 124 is/are provided on one or both sides of housing 116 (FIG. 3). Display unit 132 may provide the user with information about the lifting system.

Optionally, lifting column 102 is provided with moving system 134 that is configured for moving or displacing column 102 using wheels 6,108. In the schematically illustrated embodiment drive 134 is powered by batteries 118 and/or any of the other aforementioned energy sources acting as power system for moving system 134. It will be understood that other embodiments of moving system 134 can also be envisaged, for example comprising a separate power system.

It will be understood that different configurations for the energy source can be envisaged. Inductive charger 126 may comprise charger plate 128 or charger strip that enables inductive charging of batteries 118. Also, fuel cell based power supply 122 (for example using hydrogen, ethanol or formic acid as fuel) can be used to provide power for the column 102, for both lifting the column (carrier 112) and/or moving (driving) the column with moving system 134. The capacity of fuel cell 122 can be relatively small. For example, the “off” time of the column 102 can be used to (slowly) charge batteries 118. Batteries 118 will act as an energy buffer and will be discharged when power is needed by column 102. Also, a drive for moving lifting column 102 can be provided that uses one or more of a hydrogen powered drive, electric drive, or other suitable drive, optionally in combination with another drive such as fuel cell 122.

Lifting column 102 (FIG. 4) comprises movement sensor system 136 (FIGS. 5A-B) that comprises detector or sensor 138 that detects movement of wheel or pulley 140. Wheel or pulley 140 is mounted on shaft 142 and has toothing 141 with a number of teeth 141a. Cord 144 initiates movement of wheel or pulley 140. Cord 144 runs through protective tube 146 and is at first end 148 connected to carrier 112 with hook 150, or other suitable connecting means, and at a second end provided with a weight. In the illustrated embodiment cord 144 runs through tube or pipe 146 with (schematically illustrated) weight 152. Detector 138 detects teeth 141a of wheel or pulley 140. This provides an additional safety measure and/or measurement system to monitor desired and/or undesired movements of carrier 112.

In the illustrated embodiment reference sensor 153 (FIG. 4) is provided at some distance above ground surface 104. Reference sensor 153 provides a height reference to movement sensor system 136, thereby improving the height measurement accuracy. This prevents a decreasing measurement inaccuracy due to sensor or detector 138 missing a teeth 141a when starting or stopping a lifting operation, for example. Reference sensor 153 provides a height reference and enables a calibration of sensor 138. In a presently preferred embodiment reference sensor 153 is provided at a height of about 120 mm above ground surface 104 at the so-called foot protection height. At this height a lowering instruction of carrier 112 generally requires confirmation by an operator to prevent injuries and to enable continuation of the lowering movement, otherwise movement of carrier 112 is stopped.

Lifting column 102 (FIG. 4) comprises locking rail 154 of locking system 156. Locking rail 154 comprises a number of supporting surfaces 158 (FIG. 6). Locking element/pawl 160 is provided with support surface 162. In a locked position, support surface 162 of pawl 160 engages one of the supporting surfaces 158 of rail 154. On the other side of locking element 160 secondary support surface 164 can be supported by support 166. Lock actuator 170 acts as drive for locking element 160 and moves element 160 between a locked state and an unlocked state using plunger or shaft 172, with bolt 174 allowing the movement between both states. It will be understood that an alternative locking mechanism 156 can also be envisaged in accordance with the present invention. In the illustrated embodiment lock sensor 176 comprises an inductive sensor that measures the position of cam 178. Locking controller 180 is operatively connected to actuator 170, sensor 176, and the (overall) lifting controller, or is integrated therewith. In a first embodiment rail 154 is provided on carrier 112 and locking element 156 is provided on frame/mast 110 of lifting column 102. In a second embodiment rail 154 is provided on frame/mast 110 of lifting column 102 (FIG. 4) and locking element 156 is provided on carrier 112. Optionally, engagement sensors 182 (schematically illustrated in FIG. 6) are provided as an alternative to, or can be used in combination with, lock sensor 176. Engagement sensors 182 are preferably also connected to controller 180. Sensors 182 detect an actual engagement of surfaces 162 and 158. When sensors 176, 182 detect a safe locking a visual indication can be given to the operator on display 132, for example.

Lifting system 202 (FIG. 7) comprises four mobile lifting columns 102 with respective displacement mechanisms 2. It will be understood that another number of lifting columns 102 can also be envisaged in accordance to the present invention, for example depending on the type of vehicle 205. Lifting columns 102 lift passenger car 205 from ground surface 104.

Lifting columns 104 are connected to central controller 204, preferably by wireless communication means 206 (schematically illustrated) on individual lifting column 102 and wireless communication means 208 of central controller 204. Wireless communication means 206, 208 involve one ore more transmitters and/or receivers. Optionally, controller 204 is provided with display 210 (schematically illustrated). Central controller 204 can be provided in or on an individual lifting column 102 and/or as a separate controller that is integrated in a tablet or mobile phone and/or at a central location in the workshop, optionally above lifting system 202. In the illustrated embodiment central controller 204 is provided at a ceiling above lifting system 202 assuring a good communication path between the individual lifting columns 102 and the central controller 204. Alternatively, central controller 204 can be provided as a separate unit at a desired location in the workshop. Optionally, in such alternative embodiment central controller 204 comprises a portable housing to enable an effective displacement of central controller 204.

Optionally, central controller 202 is configured to control multiple groups of lifting systems 2a, 2b. In such embodiment central controller 202 can be used to control first set 202 of lifting columns 102 and/or second set 202a of lifting columns 102. Operation and control of a single set 202, 202a is substantially similar to the operation and control of a single system 202 with lifting columns 102. Optionally, first computing means 212 involving a first processor is provided with second or further computing means 214 involving second processor. Furthermore, central controller 204 can be provided with additional components to improve overall control operation and robustness.

Optionally, central controller 204 is operatively connected to a number of communicators/distributors 216, such as an RF-host, that send and/or receive (wireless) signals 218 between lifting columns 102 and/or between lifting columns 102 and communicator 216, and signals 220 between communicator/distributor 216 and central controller 204. Communicators/distributors 216 provide additional robustness to the overall operation of the groups 202, 202a of lifting columns 102.

Central controller 204 determines the desired control actions. In one of the embodiments of the invention this may involve receiving a measurement signal measuring the actual height of carrier 112 of individual lifting column 102 that is measured with height or movement sensor 222 (schematically illustrated) that is attached to an individual lifting column 102. Sensor 222 is capable of measuring position and/or speed of carrier 112. In the illustrated embodiment sensor 222 is a potentiometer and/or an inclinometer. In an embodiment of the invention controller 204 involves directly and/or indirectly measuring the hydraulic liquid level, pressure, or volume and/or a change thereof, that is schematically illustrated as indirect sensor 224. This may include a flow measurement of the hydraulic liquid between drive 114 of carrier 112 and the hydraulic liquid reservoir. This provides an effective control of the lifting operation. Also, movement sensor 136 (FIG. 4) can be applied.

Furthermore, the use of both a direct and an indirect, or multiple indirect sensors 222, 224 and/or movement sensor 136 provides central controller 204 with the ability to increase the measurement accuracy by combining the measurements into a single measurement value. This may involve the calculation of an average height, optionally including weighing factors for individual measurements depending on sensor accuracy, for example. In addition, an indirect height measurement from the hydraulic system can be used as a feedforward signal in an embodiment of an indirect sensor 224 and can be used in combination with a direct measurement of the actual height as a feedback signal of an embodiment of a direct sensor 222. A further advantage of providing an indirect height measurement from the hydraulic system is that any leakage from the system can be detected such that appropriate action can be taken.

Optionally, pressure or load sensor 226 may be used for monitoring, control and indication of the correct positioning of the load that is lifted with lifting system 202. Optionally, vehicle detector 228 (schematically illustrated) is provided to detect the presence of vehicle 205. One or more of these sensors can be used to inform controller 204 of lifting activities of carrier 212. Alternatively, or in addition thereto, motor run time sensor 276 may provide controller 204 with motor run time information of motor 114 and/or pump activity sensor 278 may provide controller 204 with pump activity information of pump 280. Alternatively, or in addition thereto, load sensor 226 may provide central controller 204 with information on the actual loads carried by carrier 112, preferably in combination with the time period the carrier 112 is exposed to the load. It will be understood that alternative sensors can be used in combination or as an alternative.

In the illustrated embodiment, central controller 204 may store data in memory/storage 230. Optionally, indoor positioning system 232 is provided to determine position and/or height of carrier 112 with transmitters/sensors 234 and optionally making use of further sensors 236 attached to or provided in control box 238 and/or sensor 226 attached to carrier 112 that optionally provides a dual function as load sensor and position sensor. Central controller 204 is optionally provided with a wired and/or wireless connection 240 to enable connection between communication module 242 of central controller 204 to internal and/or external networks, involving internal company networks for workshop control 244, financial control 246 and maintenance 248, for example, and external networks 250 of suppliers and/or customers, for example.

Central controller 204 (FIG. 7) can be provided with locking controller 180 (FIG. 6) and/or locking controller 180 can be provided in control box 230 of individual lifting column(s) 104. In the illustrated embodiment, in addition, or as an alternative, remote control 204a is provided with display 204b.

In the illustrated embodiment lifting system 202 is connected to electrical grid 252 via connection 254. Lifting columns 102 can be connected directly to electrical grid 252 and/or can be interconnected via connections 256. Lifting columns 102 preferably comprise CEE-connectors 258, although other suitable connectors can also be envisaged in accordance to the present invention. Also, optional communicator 216 can be connected to electrical grid 252, either directly via connection 260 and/or via central controller via connection 262 and/or via a lifting column via connection 264. In addition, or as an alternative, power can be provided to lifting column 102 and/or lifting system 202 with the use of solar panels or solar strips 124 (FIG. 3), fuel cell 122 (FIG. 3), inductive charger 126, 128 (FIG. 3), regenerative system 124 (FIG. 3). Alternatively, or in addition thereto, vehicle battery 266 and connector 267 provides energy to lifting system 202 or individual lifting column 102 thereof.

In the illustrated embodiment individual lifting columns 102 (FIG. 7) are provided with display 268 that is provided in or at control box 230. Display 268 preferably relates to a touch screen. Control box 230 optionally comprises a number of buttons 270 to provide additional input means for a user, an RFID antenna 272 enabling a user to identify himself with an ID-key 274 and/or pay for a number of lifts with a pre-paid card. As indicated earlier, in the illustrated embodiment control box 230 further comprises position determining means 236 and communication means 206, preferably providing wireless functionality to communicate in one or more environments such as LAN, WAN, VPN intranet, internet etc. that are schematically shown in the illustrated embodiments. Control box 230 is further provided with input/output ports, such as USB, SD card reader, smart phone communication possibilities etc. to improve the functionality. Display 230 may provide warning signals to the user. Display 230, preferably a TFT-LCD, is protected by a display lens cover of a resilient material, preferably scratch-resistant. Also, control box 230 may comprise a local controller that acts as central controller 204 or that co-operates with central controller 204. Optionally, the local controller communicates with (local) controllers of other lifting columns 102.

In use, when lifting vehicle 205 a number of mobile lifting columns 102 are positioned around vehicle 205 using displacement system(s) 2. When the lifting operation is approved carriers 112 start moving along masts 110. During a lifting operation, central controller 204 detects movement, height differences, and/or speed differences between individual lifting columns 102 and/or differences between the status and/or actions of drive(s) 118, calculates the required control actions with computing means 212, such as a processor, for individual lifting columns 102, and communicates the control actions to the relevant individual lifting columns 102. Transmitter/receivers 206, 208 provide user instructions to central system controller 204. On a central level controller 204 determines the individual control actions to be taken for all lifting columns 102 in system 202, 202a. These control actions may result in sending control signals/actions to motor 114, for example. As soon as the desired height above ground surface 104 is reached, locking system 180 is activated. Lowering vehicle 205 and relocating columns 102 and displacement systems 2 is performed in a similar manner.

Height differences between individual lifting columns 102 within one set 202, 202a are detected and corrected by controller 204. This correction can be performed by increasing the speed of the “slowest” lift(s) that is behind while ascending or descending. Alternatively, the “fastest” lift(s) can be corrected. For example, the lift that ascends or descends faster than the other lifts can be adjusted. This adjustment may involve sending an adjusting steering signal to the (lifting) drive of the carrier of the specific lift.

Alternative lifting column 102′ (FIG. 8) comprises the same or similar components as compared to lifting column 102. Operation of lifting column 102′ is the same or similar as compared to that of lifting system 102. A specific element of lifting column 102′ is power box 282 having a number of connections 283. Columns 102′ and/or power boxes 282 can be connected with power cable 284 having power plug 286, preferably a customized IEC plug. In the illustrated embodiment power box 282 is provided with power switch and/or reset button 288. Power box 282 can be attached to lifting column 102′ with connecting means 290, such as bolts, clips, hooks and/or other suitable means. This enables a modular power box 282 being customized to the local power regulations and power supply or supplies. Power boxes 282 can be connected to electrical grid 252 and/or other suitable power supply. Power boxes 282 enable interconnecting adjacent lifting columns 102′ in a lifting system. Preferably, lifting columns 102′ on one side of the (lifted) vehicle are connected to prevent power cables 284 to extend between the different sides of the vehicle and being driven over.

Lifting system 302 (FIG. 9) comprises four mobile lifting columns 102″ that in the illustrated embodiment comprise displacement system 2. It will be understood that also another number of lifting columns 102″ can also be envisaged in accordance to the present invention. Optionally, different column types 102, 102′, 102″ can be applied in a lifting system.

Lifting columns 102′ are preferably connected to central controller 204, preferably by wireless communication means 206 exchanging wireless signals 218. Central controller 204 is schematically illustrated in FIG. 9 and can be embodied as a physical central controller at a different location removed from lifting columns 102″ (FIG. 9), or can be embodied as a controller of one or more of the lifting columns 102″ that acts as (central) controller(s) 204 for lifting system 302.

Optionally, central controller 204 communicates with system 300 that may involve maintenance, communication, scheduling and/or financial information. Lifting columns 102″ (FIG. 9) provide the same or similar features as compared to lifting columns 102 (FIG. 7). Operation of lifting system 302 is the same or similar as compared to that of lifting system 202.

In the illustrated embodiment, lifting columns 102″ (FIG. 9) are connected to electrical grid 252 that acts as central power supply to lifting columns 102″. Power cables 304 provide power from supply 252 to columns 102″. Alternatively, or in combination therewith, power can also be applied from one column to another via power cables (not shown). Preferably, power cables 304 are provided with flexible part 306 that is schematically illustrated in FIG. 9 and enables lifting columns 102″ to move over a certain distance without requiring disconnecting lifting columns 102″ from power supply 252.

In the illustrated embodiment distancing system 308 is shown. Distancing system 308 comprises subsystems 310 at each column 102′. Subsystem 310 comprises arm 312 with first part 314 and second part 316. Optionally, first and second arm parts 314, 316 are telescopic parts. At first end 318 hinge 320 connects subsystem 310 to lifting column 102″. At second end 322 barrier housing 324 is provided that preferably houses barrier tape 326. Barrier tape 326 can be pulled from housing 324 and connected to clip 328 of another subsystem 310 of an adjacent lifting column 102″, for example. In the illustrated embodiment arm 312 is supported by arm support 330 having two support arms 332a,b that are connected via support hinge 334. Arm support 330 is connected to lifting column 102′ and arm 312. Distancing system 308 provides a safety system around lifting system 302 to prevent people from entering the working zone of lifting system 302. It will be understood that distancing system 308 can also be applied to other lifting systems, for example lifting system 202.

Battery safety circuit 401 (FIG. 10) comprise reservoir or tank 404 that is operatively connected to pump 406 and motor 408. Valves 410, 412 determine flow direction. Connection 414 connects circuit 402 to the lifting cylinder. Motor 408 is operatively connected to battery 416, resistor 418 and/or capacitor 420. In operation, when lifting a vehicle, motor 408 drives pump 406. Pump 406 provides the cylinder with hydraulic energy when valves 410, 412 are opened. When lowering/descending the vehicle hydraulic liquid returns from the cylinder to reservoir 404. By opening valves 410, 412 the liquid flows through pump 406 that (re)generates electrical energy that can be stored in battery 416. This enables regeneration of energy so that the number of lifts with one battery charge is significantly increased. In case battery 416 is already charged the regenerating may result in overcharging and damaging battery 416. This can be prevented by controlling the flow through valve 412. For example, valve 412 is a so-called pulse width modulation (pwm) valve that is preferably proportionally controlled. This enables control of the flow and the amount of (re)generated energy. In fact, energy is “lost” as heat and overcharging is prevented. It will be understood that other valve types can also be envisaged in accordance to the present invention.

Optionally, other remedies can be envisaged. For example, resistor 418 can be applied to reduce the storage of energy that is (re)generated, or energy is stored in capacitor 420. These remedies can be applied in addition, or as an alternative, to pwm-valve 412.

It will be understood that other embodiments, combinations of illustrated features, and configurations can be envisaged in accordance with the present invention.

The present invention is by no means limited to the above described preferred embodiments. The rights sought are defined by the following claims within the scope of which many modifications can be envisaged. For example, lifting columns according to the invention include wired or wireless mobile type lifting columns, lifting columns of the two-post lift type with pivoting support arms, the four-post lifting column types with runways, the, in-ground lifts etc.

In addition, it will be understood that communication between lifting devices and/or with a (central) controller may involve the use of wireless communication. This reduces the amount of cables in a workshop, thereby improving the safety of working in such workshop. Wireless communication can be performed at different bandwidths, for example in the radio spectrum such as within a bandwidth of 300-430 kHz. It will be understood that the use of other bandwidths can also be envisaged. It will be understood that this wireless communication, preferably within this specific bandwidth, can be also be applied to sets of only mobile lifting columns.

1. A manual displacement mechanism for a pallet truck or lifting device, the displacement mechanism comprising:
a displacement frame comprising a housing, and a wheel that is provided at a first end of the housing, wherein the wheel is moveable relative to the frame between a displacement position wherein the pallet truck or lifting device can be displaced and a stationary position wherein the pallet truck or lifting device is in a stationary position;
a steering handle that is operatively coupled to the wheel with a linkage mechanism that is configured for moving the wheel relative to the frame, and wherein the steering handle is connected to the displacement frame at a second end of the housing; and
a connector configured for connecting the manual displacement mechanism with the pallet truck or lifting device, wherein the connector comprises a hinge for hingedly connecting to the pallet truck or lifting device and a connector spring element configured for providing a pre-tension on the wheel.

2. The manual displacement mechanism according to claim 1, wherein the connector spring element comprises one or more disc springs.

3. The manual displacement mechanism according to claim 1, further comprising a counter force element that is provided in or on the frame.

4. A mobile lifting column for lifting a vehicle, the column comprising:
a frame with a moveable carrier, wherein the carrier comprises a carrier part and a guiding part with the carrier being configured for carrying the vehicle;
a drive system which acts on the carrier and is configured for raising and/or lowering the carrier relative to the frame;
a lifting controller configured for controlling movement of the carrier; and
a displacement mechanism for a pallet truck or lifting device, the displacement mechanism comprising:
a displacement frame comprising a housing, and a wheel that is provided at a first end of the housing, wherein the wheel is moveable relative to the frame between a displacement position wherein the pallet truck or lifting device can be displaced and a stationary position wherein the pallet truck or lifting device is in a stationary position;
a steering handle that is operatively coupled to the wheel with a linkage mechanism that is configured for moving the wheel relative to the frame, and wherein the steering handle is connected to the displacement frame at a second end of the housing; and
a connector configured for connecting the manual displacement mechanism with the pallet or lifting device, wherein the connector comprises a hinge for hingedly connecting to the pallet truck or lifting device and a connector spring element configured for providing a pre-tension on the wheel.

5. The mobile lifting column according to claim 4, further comprising a movement sensor system configured for detecting a movement of the carrier, wherein the movement sensor system comprises a detector, a pulley that is rotatable around a shaft for enabling movement of a cord or belt, and a movement indication that is provided on or to the pulley and/or cord or belt.

6. The mobile lifting column according to claim 5, wherein the detector is configured for detecting the direction of movement.

7. The mobile lifting column according to claim 5, wherein the movement indication comprises a toothing.

8. The mobile lifting column according claim 4, further comprising an indirect height measurement system.

9. The mobile lifting column according to claim 4, further comprising a locking mechanism for mechanically locking the carrier at a desired height, wherein the locking mechanism comprising a moveable locking element capable of locking and unlocking the carrier, a lock sensor for measuring the position of the locking element, and a locking controller that is configured for detecting locking of the carrier in response to the locking sensor and an operator input for lowering the carrier.

10. The mobile lifting column according to claim 4, further comprising a locking system for locking and unlocking the moveable carrier relative to the frame, wherein the locking system comprises an electromagnetic lock actuator and an electromagnetic locking drive configured for moving the lock actuator between a locked state and an unlocked state, wherein the locking drive provides a first moving voltage and a second holding voltage that is lower than the first moving voltage.

11. The mobile lifting column according claim 4, further comprising a wireless communication controller configured for wireless communication with a controller and/or other lifting columns, and a wired connection to an external energy source.

12. The mobile lifting column according to claim 11, wherein the external energy source comprises a vehicle battery.

13. The mobile lifting column according to claim 11, wherein the external energy source comprises a connection to the electrical grid.

14. The mobile lifting column according to claim 11, further comprising a battery safety circuit configured for preventing overcharging of a battery.

15. The mobile lifting column according to claim 14, wherein the battery safety circuit comprising one or more of a throttle valve, resistor, and/or capacitor.

16. The mobile lifting column according to claim 4, further comprising a distancing system.

17. (canceled)

18. A method for displacing a device, the method comprising the steps of:
providing displacement mechanism for a pallet truck or lifting device, the displacement mechanism comprising:
a displacement frame comprising a housing, and a wheel that is provided at a first end of the housing, wherein the wheel is moveable relative to the frame between a displacement position wherein the pallet truck or lifting device can be displaced and a stationary position wherein the pallet truck or lifting device is in a stationary position;
a steering handle that is operatively coupled to the wheel with a linkage mechanism that is configured for moving the wheel relative to the frame, and wherein the steering handle is connected to the displacement frame at a second end of the housing; and
a connector configured for connecting the manual displacement mechanism with the pallet or lifting device, wherein the connector comprises a hinge for hingedly connecting to the pallet truck or lifting device and a connector spring element configured for providing a pre-tension on the wheel;
bringing the displacement mechanism from a stationary position to a displacement position;
moving the device; and
bringing the displacement mechanism from the displacement position to the stationary position.

19. The method according to claim 18, wherein the device is a mobile lifting column.

20. (canceled)

21. (canceled)

22. (canceled)

23. (canceled)

24. The mobile lifting column according to claim 5, further comprising a locking mechanism for mechanically locking the carrier at a desired height, wherein the locking mechanism comprising a moveable locking element capable of locking and unlocking the carrier, a lock sensor for measuring the position of the locking element, and a locking controller that is configured for detecting locking of the carrier in response to the locking sensor and an operator input for lowering the carrier.

25. The mobile lifting column according to claim 5, further comprising a locking system for locking and unlocking the moveable carrier relative to the frame, wherein the locking system comprises an electromagnetic lock actuator and an electromagnetic locking drive configured for moving the lock actuator between a locked state and an unlocked state, wherein the locking drive provides a first moving voltage and a second holding voltage that is lower than the first moving voltage.
